(19) United States
(12) Patent Application Publication
(10) Pub. No.: US 2024/0401586 A1
(43) Pub. Date: Dec. 5, 2024

(54) ARTIFICIAL INTELLIGENCE-DRIVEN CLASSIFICATION WORKFLOW FOR DIAGNOSIS OF SUCKER ROD PUMP OPERATING CONDITIONS

(71) Applicant: Schlumberger Technology Corporation, Sugar Land, TX (US)

(72) Inventors: Amey Ambade, Houston, TX (US); Piyush Umate, Houston, TX (US); Supriya Gupta, Houston, TX (US); Abhishek Sharma, Richmond, TX (US)

(21) Appl. No.: 18/694,581

(22) PCT Filed: Oct. 26, 2022
(86) PCT No.: PCT/US2022/047893

§ 371 Date: Mar. 22, 2024

Related U.S. Application Data
(60) Provisional application No. 63/272,999, filed on Oct. 28, 2021.

(51) Int. Cl. F04B 51/00; E21B 47/12; F04B 47/02; G06N 3/0464; G06N 20/10

(52) U.S. Cl. CPC F04B 51/00; E21B 47/12; F04B 47/02; G06N 3/0464; G06N 20/10

(57) ABSTRACT

Methods and systems are provided for monitoring the operation of a sucker rod pump (SRP), which involves a workflow that processes surface operational data and downhole operational data related to the operation of the SRP. The surface operational data is derived from real-time measurements performed by surface-located sensors, while the downhole operational data is derived from real-time measurements performed by downhole sensors. The surface operational data is processed to generate input data for supply to a first machine learning model (e.g., Surface Data Classifier) and the downhole operational data is processed to generate input data for supply to a second machine learning model (e.g., Downhole Data Classifier). The output of at least one of the first and second machine learning models is used to characterize an operational condition or status of the SRP.

### CROSS-REFERENCE TO RELATED APPLICATION(S)

The present application claims priority from U.S. Provisional Application No. 63/272,999, filed on Oct. 28, 2021, herein incorporated by reference in its entirety.

### FIELD

The present disclosure relates to the analysis of real-time operational data of a sucker rod pump for characterizing operating conditions, such as Tagging, Gas Interference, Fluid Pound, or Normal operating conditions, of the sucker rod pump.

### BACKGROUND

Sucker Rod Pumps (SRPs) are used for efficient extraction of oil at wellsites around the world. As shown in FIG. 1, an SRP includes a surface-located pumping unit (sometimes referred to as a pumpjack) jack that is connected to a downhole pump disposed within a well by a polished rod at the surface together with a series of interconnected sucker rods that extend down the well. The SRP functions by transporting fluid in an upward direction within the well based on the periodic movement of the downhole pump which is actuated by the pumping unit and interconnected sucker rods. Sensors located at or near the surface can measure real-time data related to the operation of the SRP. The real-time data from the surface-located sensors can be processed together with a mathematical model to generate data (typically referred to as a Dynacard or pump card) that represents the loading of the downhole pump of the SRP over the pump cycle. The Dynacard can be evaluated to characterize or diagnose operating conditions, such as Tagging, Gas Interference, Fluid Pound, or Normal operating conditions, of the sucker rod pump.

### SUMMARY

The present disclosure describes methods and systems for monitoring the operation of a sucker rod pump (SRP), which involve a workflow that processes surface operational data and downhole operational data related to the operation of the SRP. The surface operational data is derived from real-time measurements performed by surface-located sensors, while the downhole operational data is derived from real-time measurements performed by downhole sensors. The surface operational data is processed to generate input data for supply to a first machine learning model (e.g., Surface Data Classifier), and the downhole operational data is processed to generate input data for supply to a second machine learning model (e.g., Downhole Data Classifier). The output of at least one of the first and second machine learning models is used to characterize an operational condition or status of the SRP.

In embodiments, the first machine learning model can be trained to predict whether the SRP is Tagging or Not Tagging given the input data derived from the surface operational data.

In embodiments, the first machine learning model can be trained to predict confidence levels for two operational states or conditions of the SRP representing whether the SRP is Tagging or Not Tagging.

In embodiments, the input data supplied to the first machine learning model can represent a histogram of oriented gradient (HOG) features derived from the surface operational data.

In embodiments, the first machine learning model can be a support vector machine (SVM) classifier.

In embodiments, the second machine learning model can be trained to predict a set of operational states or conditions of the SRP given the input data derived from the downhole operational data.

In embodiments, the second machine learning model can be configured to selectively predict a set of operational states or conditions of the SRP based on results of the first machine learning model.

In embodiments, the second machine learning model can be configured to selectively predict a set of operational states or conditions of the SRP if the first machine learning model predicts that the SRP is Not Tagging.

In embodiments, the input data supplied to the second machine learning model can represent an image derived from the downhole operational data. For example, the image can be derived from data representing downhole operational characteristics of the SRP.

In embodiments, the second machine learning model can be a deep learning model, such as a convolutional neural network model.

In embodiments, the SRP is located at a wellsite, and some or all of the operations of the workflow are performed by a software application executing on a gateway or edge controller located at or near the wellsite.

In other embodiments, the SRP is located at a wellsite and some or all of the operations are performed by a software application executing on a remote system (such as a cloud service or cloud computing environment) that communicates with a gateway or edge controller located at or near the wellsite.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic illustration of a rod sucker pump deployed at a wellsite;

FIG. 2 is a flow chart of a workflow for characterizing operating conditions of a sucker rod pump in accordance with the present disclosure;

FIGS. 3A and 3B illustrate operations in developing and training the Surface Data Classifier of the workflow of FIG. 2 using supervised learning in accordance with the present disclosure;

FIGS. 4A and 4B illustrate operations in developing and training the Downhole Data Classifier of the workflow of FIG. 2 using supervised learning in accordance with the present disclosure;

FIG. 5 are plots illustrating SHAP analysis of Downhole Cards that are used in the workflow of FIG. 2 in accordance with the present disclosure;

FIG. 6 illustrates results of the Surface Data Classifier and Downhole Data Classifier used in the workflow of FIG. 2 in accordance with the present disclosure;

FIG. 7 is a schematic diagram of a system for operational surveillance of a sucker rod pump deployed at a wellsite (e.g., well pad) in accordance with the present disclosure;

FIG. 8 is a schematic illustration of a software implementation of the analysis framework of the workflow of FIG. 2 embodied by the system of FIG. 7;

FIG. 9 illustrates various processes used in the workflow of FIG. 2 in accordance with the present disclosure; and

FIG. 10 is a schematic diagram of an example computing system.

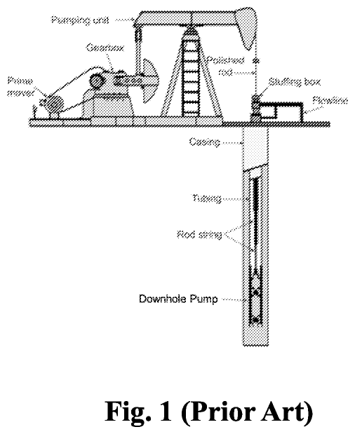

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

The present disclosure provides a workflow that uses machine learning and computer vision to characterize operating conditions of an SRP by performing automated interpretation and diagnosis of a well and SRP and operational issues of the well and SRP using both downhole operational data and surface operational data. The workflow can be operationalized as a versatile and extendable conditional framework. In embodiments, the workflow can be embodied in a standalone containerized software application, which can be optimized for edge enablement and real-time insights.

In embodiments, the workflow employs multiple machine-learning models that can be built by utilizing computer vision techniques like deep convolutional neural networks (CNNs), transfer learning and histogram of oriented gradient (HOG) feature generation, and other machine learning techniques like support vector machines (SVMs). The multiple machine-learning models are embedded in the workflow to systematically process the surface operational data followed by the downhole operation data and provide a prediction of the operational status of the SRP and diagnosis of the operational status of the SRP in real-time.

In embodiments, the workflow can ingest, load and position vectors from real-time sensor data, perform data validation, normalization, image generation, and preprocessing. SVM-based classification can be performed using HOG features as input, and multiclass deep learning classification can be performed using an image as input. The collective results of the SVM classification and the deep learning classification can be evaluated and provided as output. These outputs can be visualized in cloud-based dashboards and reviewed by engineers to trigger appropriate mitigation workflows as required.

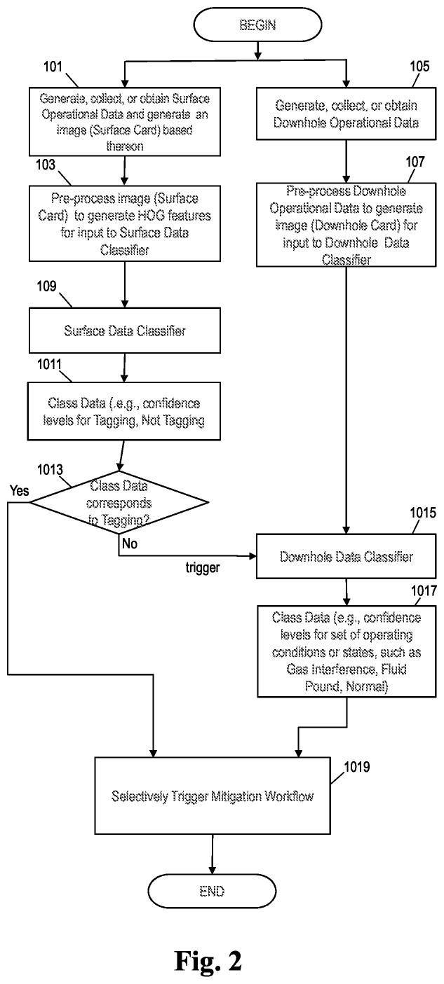

FIG. 2 illustrates an embodiment of the workflow, which involves generating or collecting surface operational data from real-time measurements performed by one or more surface-located sensors and generating an image (referred to as a “Surface Card”) that relates to the operation of the SRP from the surface operational data (block 101). For example, the surface-located sensors can include a dynamometer (or other load sensor) installed on the polished rod of the pumping unit that measures the load on the polished rod and a surface-located position sensor (or other sensor) that measures the position or displacement of the polished rod of the pumping unit, which together provide a measure of the load on the polished rod as a function of displacement of the polished rod as the pumping unit moves through the pumping cycle (e.g., from the upper dead point to the lower dead point of the rod and back up again). The measurements of load as a function of displacement of the polished rod can be collected and plotted as a two-dimensional image (or Surface Card) with load represented by one dimension and displacement represented by the other dimension of the image. In block 103, a histogram of oriented gradient (HOG) features related to the operation of the SRP is constructed from the image (Surface Card) of block 101. The HOG features can be derived by calculating the magnitude and orientation of the gradient for pixel values in localized portions of the image (Surface Card) and then creating a histogram of the magnitude and orientation of the gradient for each region.

The workflow can also involve generating or collecting downhole operational data from real-time measurements (such as load and position data of the downhole pump) performed by downhole sensors (block 105). In block 107, data validation, normalization, and preprocessing can be performed that generate an image (referred to as a “Downhole Card”) that is related to the operation of the SRP from the downhole operational data of 105. For example, the downhole-located sensors can include one or more strain sensors (or other load sensors) and one or more position sensors, which together provide a measure of the load on the downhole pump as a function of the position or displacement of the downhole pump as the surface-located pumping unit and sucker rods actuate the movement of the downhole pump through its pumping cycle. The measurements of the load as a function of the position of the downhole pump can be collected and plotted as a two-dimensional image (or Downhole Card) with the pump load represented by one dimension and the pump position represented by the other dimension of the image

In block 109, the data representing the HOG features of 103 is supplied as input to a machine learning system (labeled “Surface Data Classifier”) that is trained to output class data (block 1011) that predicts whether the SRP is Tagging or Not Tagging given the HOG feature input data. The Tagging of the SRP relates to improper pump spacing. More specifically, when the SRP is Tagging, contact is made between the plunger and the bottom of the SRP at the bottom of the stroke of the SRP and/or contact is made between the plunger and the top of the SRP at the top of the stroke of the SRP. When the SRP is Not Tagging, no contact is made between the plunger and the bottom of the SRP at the bottom of the stroke of the SRP and no contact is made between the plunger and the top of the SRP at the bottom of the stroke of the SRP. In embodiments, the Surface Data Classifier of 109 can be embodied by a support vector machine (SVM)-based classifier. The SVM-based classifier can employ one or more hyperplanes in the original input space or a transformed feature space to produce the output class data that predicts whether the SRP is Tagging or Not Tagging given the HOG feature input data. The output class data produced by the Surface Data Classifier of 109 can represent confidence levels or probabilities that the SRP is Tagging or Not Tagging. In embodiments, the Surface Data Classifier 109 can be embodied by an SVM binary classification model.

In block 1013, the class data output by the Surface Data Classifier of 109 is evaluated to determine if such class data predicts that the SRP is Tagging, and if so, selectively triggers processing in block 1015 that supplies the image (Downhole Card) of block 107 as input to another machine learning model (labeled “Downhole Data Classifier”) that is trained to output class data (block 1017) that predicts an operational state or condition of the SRP given the image (Downhole Card) of 107 as input. In embodiments, the Downhole Data Classifier 1015 can be embodied by a multiclass deep learning model. The class data output by the Downhole Data Classifier of 1015 can represent confidence levels or probabilities for a set of operational states or conditions of the SRP, such as Gas Interference, Fluid Pound, and Normal operating states of the SRP.

In block 1019, the collective results of the Surface Data Classifier of 109 and the Downhole Data Classifier of 1015 (which includes the class data 1011 and the class data 1017) can be evaluated to selectively trigger a mitigation workflow. For example, as part of this mitigation workflow, the results can be visualized in cloud-based dashboards and reviewed by engineers or other users to trigger appropriate mitigation workflows as required. In one example, if and when the results of the Surface Data Classifier of 109 predict that the SRP is Tagging, the spacing of the SRP can be adjusted to reverse or diminish the Tagging, or the operation of the SRP terminated to enable the Tagging issue to be addressed by pump repair or maintenance operations. In another example, if and when the results of the Surface Data Classifier of 109 predict that the SRP is Not Tagging and results of the Downhole Data Classifier of 1015 predict that the SRP is experiencing Gas Interference, actions can be taken to alleviate the Gas Interference. In yet another example, if and when the results of the Surface Data Classifier of 109 predict that the SRP is Not Tagging and results of the Downhole Data Classifier of 1015 predict that the SRP is experiencing Fluid Pound, actions can be taken to alleviate the Fluid Pound (such as slowing down the pumping unit, shortening the stroke length or installing a smaller bottom hole pump).

In embodiments, the workflow of FIG. 2 can be dynamically embedded in a WSGI-based REST API and then packaged as a containerized software application. The containerized software application can be deployed directly on edge controllers or gateways to provide real-time operational surveillance and diagnosis of the SRP as described herein.

The operations of the workflow can be repeated over time using the time-varying sensor data as input in order to provide real-time operational surveillance and diagnosis of the SRP over time.

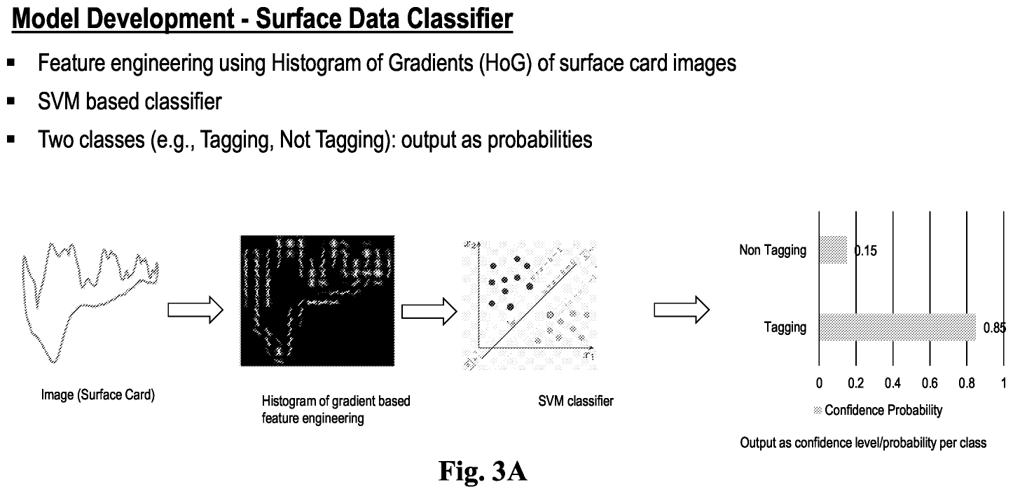

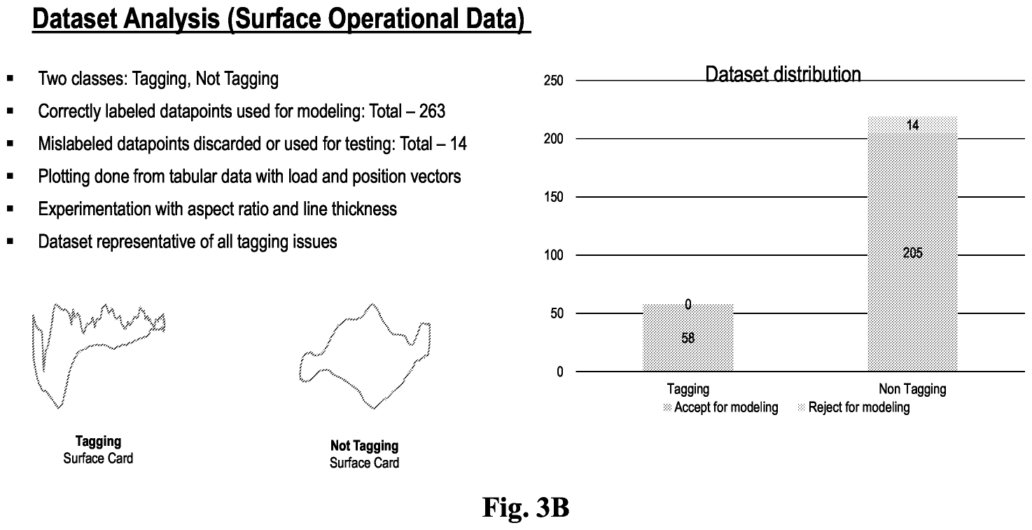

FIGS. 3A and 3B illustrate operations in developing and training the Surface Data Classifier using supervised learning. In FIGS. 3A and 3B, HOG feature data is derived from measured Surface Card data for different SRPs and labeled with confidence levels/probabilities for two classes related to Tagging and Not-Tagging operation of the SRPs. Some parts of a dataset (e.g., two hundred and sixty-three (263) surface card images and associated label data) can be accepted, while other parts of the dataset (e.g., fourteen (14) surface card images and associated label data) can be discarded or rejected. The accepted parts of the dataset (surface card images) can be processed to extract HOG feature data therefrom and the resulting HOG feature data and corresponding label data (e.g., label data representing SRP Tagging or Not Tagging) can be used to train the Surface Data Classifier to output the class data that predicts whether the SRP is Tagging or Not Tagging given arbitrary HOG feature input data. In embodiments, the Surface Data Classifier can be implemented by an SVM binary classifier model or other suitable machine learning model.

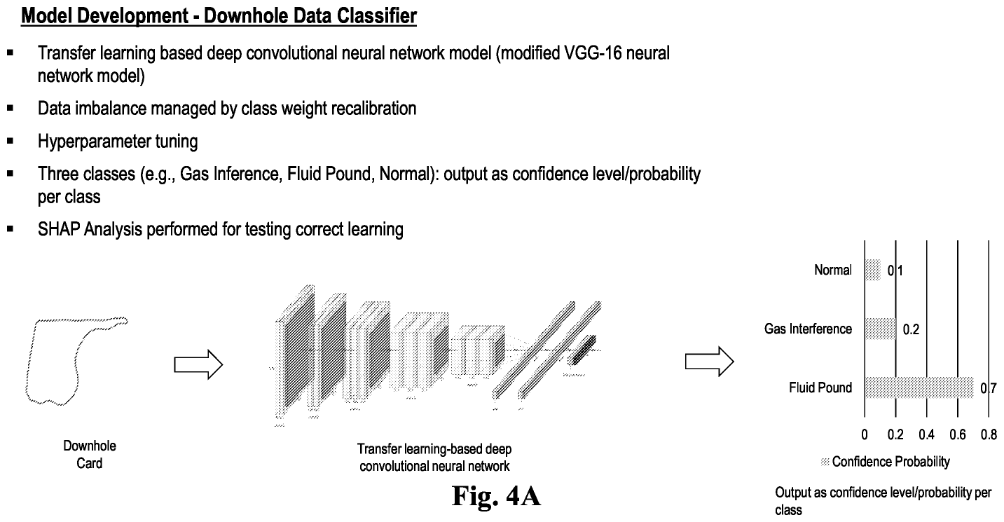

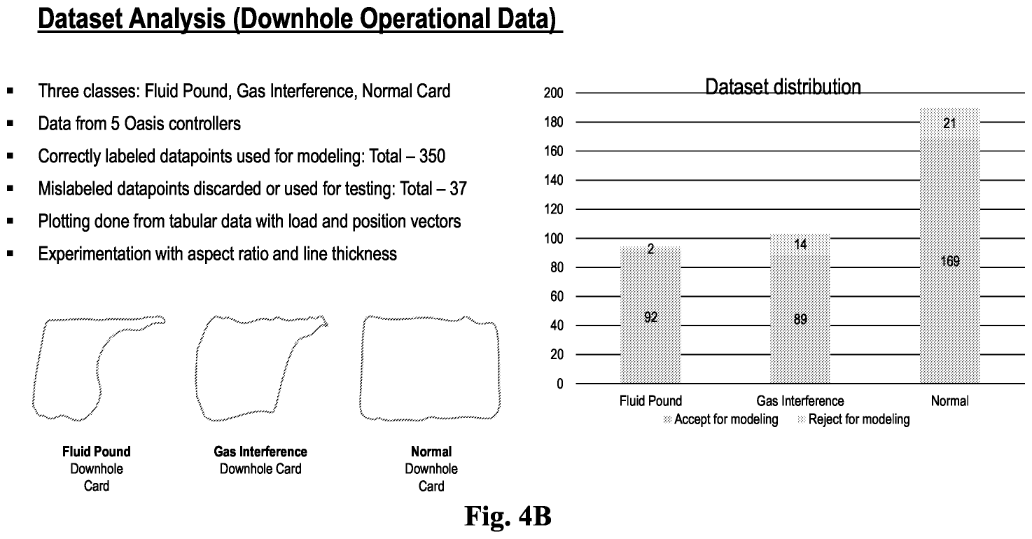

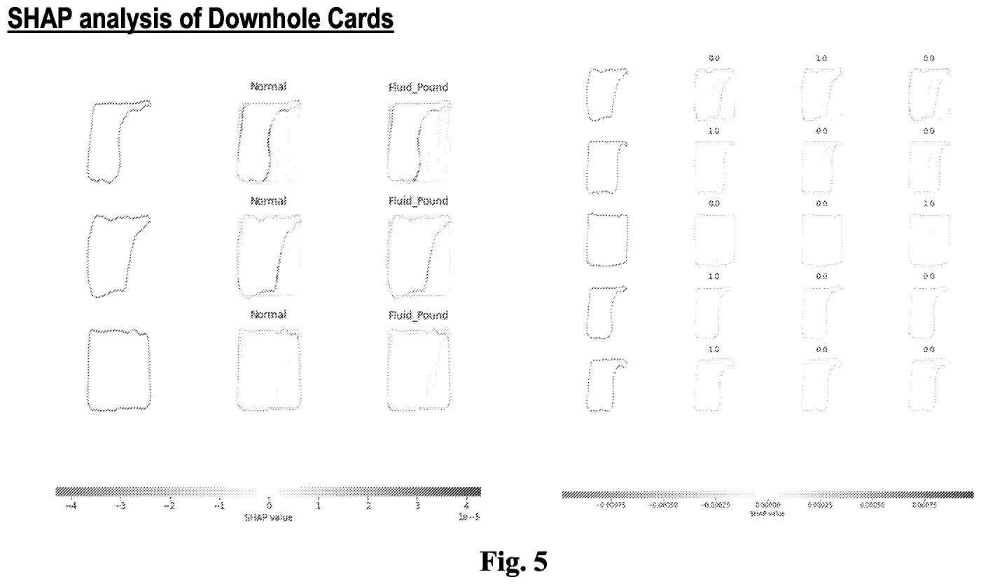

FIGS. 4A and 4B illustrate operations in developing and training the Downhole Data Classifier using supervised learning. In this example, the Downhole Data Classifier is embodied by a deep convolutional neural network model based on a modification to the VGG16 deep learning architecture, which is a convolutional neural network model proposed by K. Simonyan and A. Zisserman from the University of Oxford in the paper “Very Deep Convolutional Networks for Large-Scale Image Recognition,” arXiv preprint arXiv:1409.1556, 2014-arxiv.org. Transfer learning was used to modify a VGG-16 pre-trained network. The deep learning-based convolutional neural network includes optimized hyperparameters and additional architectural changes to represent the classification of SRP operating conditions. The class data output by the Downhole Data Classifier represents confidence levels or probabilities for a set of three operational states or conditions of the SRP, which include Gas Interference, Fluid Pound, and Normal operating states of the SRP. In FIGS. 4A and 4B, Downhole Card data is derived from measured downhole sensor data for different SRPs and labeled with confidence levels/probabilities for the set of three operational states or conditions of the SRP. Some parts of a dataset (e.g., three hundred and fifty (350) downhole card images and associated label data) can be accepted, while other parts of the dataset (e.g., thirty-seven (37) downhole card images and associated label data) can be discarded or rejected. The accepted parts of the dataset and corresponding label data (e.g., label data representing Fluid Pound, Gas Interference, or Normal Card) can be used to train the Downhole Data Classifier to output the class data that predicts the set of three operational states or conditions of the SRP given arbitrary downhole card image data as input. SHAP Analysis can be performed for testing correct learning as illustrated in FIG. 5. In other embodiments, the Downhole Data Classifier can be implemented by one or more other deep convolutional neural network models or other suitable machine learning models.

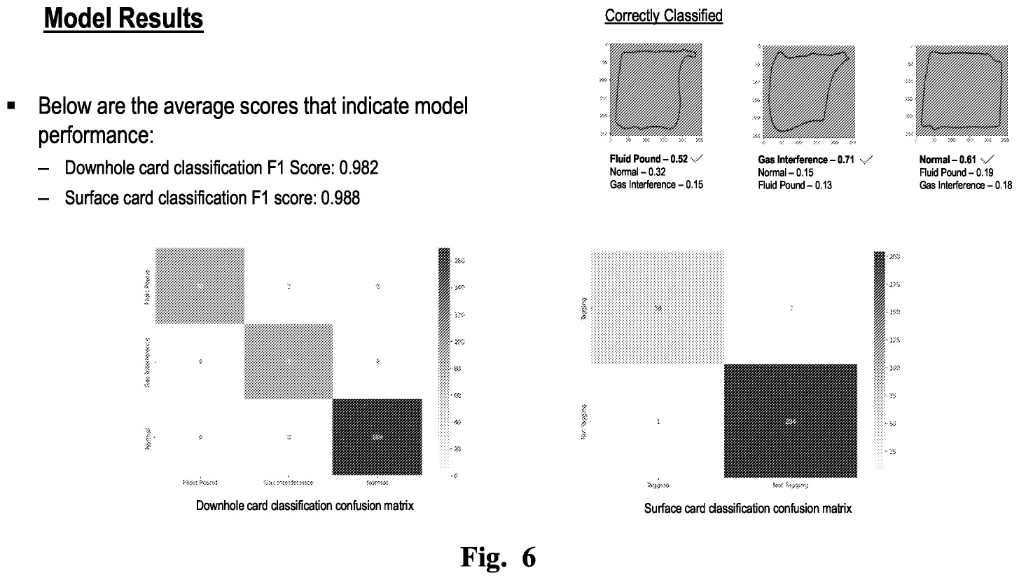

FIG. 6 shows the results of the Surface Data Classifier and Downhole Data Classifier of the workflow.

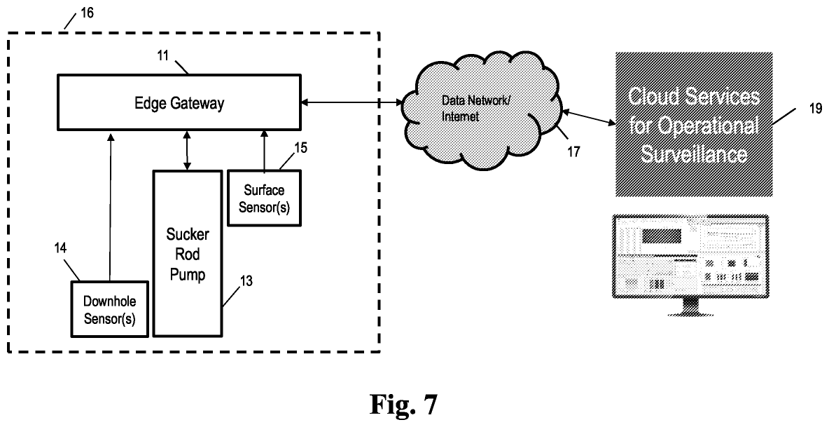

In embodiments, the workflow and processes as described herein can employ a distributed computing platform for operational surveillance of one or more SRPs (for example, one SRP labeled 13) as shown in FIG. 7. The SRP 13 is located at a wellsite 16 that produces hydrocarbons (e.g., petroleum fluids) from subsurface earth formation(s). The SRP 13 is operated to pump the hydrocarbons (e.g., petroleum fluids) from the subsurface earth formation(s) to the surface. The distributed computing platform includes an edge gateway device (or controller) 11 that is located at or near the wellsite 16. The edge gateway device 11 can be configured to receive, collect, and aggregate data from a variety of operational equipment at the wellsite 16 (such as sensors, controllers, actuators, programmable logic controllers, remote terminal units, and supervisory control and data acquisition (SCADA) systems), prepare such data for transmission to the remote cloud services 19, and transmit the data from the edge gateway device 11 to the remote cloud services 18 (also referred to as a cloud computing environment) over a data communication network 17 as shown. The data communication network 17 can include a cellular data network, satellite link, other Wide Area Network, the Internet, and/or another mode of available data communication. The cloud services 19 can be implemented by one or more processor-based systems as is well known.

In embodiments, the edge gateway device 11 can employ a compact and rugged NEMA/IP rated housing for outdoor use, making it suitable for the environments at wellsites and facilities. The overall packaging can also be environmentally qualified.

In embodiments, the edge gateway device 11 can be configured with a bi-directional communication interface (typically referred to as a Southbound Interface) for data communication to the operational equipment at the wellsite 16 using either a wired communication protocol (such as a serial, Ethernet, Modbus or Open Platform Communication (OPC) protocol) or a wireless communication protocol (such as IEEE 802.11 Wi-Fi protocol, Highway Addressable Remote Transducer Protocol (HART), LoraWAN, WiFi or Message Queuing Telemetry Transport (MATT)). The Southbound Interface can provide for direct data communication to the operational equipment at the wellsite 16. Alternatively, the Southbound Interface can provide for indirect data communication to the operational equipment at the wellsite 16 via a local area network or other local communication devices.

In embodiments, the gateway device 11 can be configured with a bi-directional communication interface (referred to as a Northbound Interface) to one or more data communication networks 17 using a wireless communication protocol or wired communication protocol. In embodiments, the wireless communication protocol can employ cellular data communication, such as 4G LTE data transmission capability (or possibly 3G data transmission for fallback capability). For facilities without a cellular signal, the Northbound Interface to the data communication network 17 can be provided by a bidirectional satellite link (such as a BGAN modem). Alternatively, the Northbound Interface can implement other wireless communication protocols or one or more wired communication protocols implemented by the data communication network(s) 17.

In embodiments, the edge gateway device 11 can employ an embedded processing environment (e.g., data processor and memory system) that hosts and executes an operating system and application(s) or module(s) as described herein.

In embodiments, the edge gateway device 11 can employ both hardware-based and software-based security measures. The hardware-based security measures can involve a hardware root-of-trust established using an industry-standard Trusted Platform Module (TPM) v2.0 cryptographic chip. The software-based security measures can include operating system hardening and encryption of both buffered and transmitted data.

In embodiments, the edge gateway device 11 can support a containerized microservice-based architecture. This architecture enables extensibility into several distinct and different solutions for different environments and applications at the edge, while still using the same infrastructure components. In embodiments, the edge gateway device 11 can employ one or more containers to implement one or more applications or modules executing on the edge gateway device 11 that perform the workflow functionality as described herein. A container is a standard unit of software that packages up code and all its dependencies (such as runtime environment, system tools, system libraries and settings) so that the application or module runs quickly and reliably in the computing environment of the edge gateway device 11. The container isolates the software from its environment and ensures that it works uniformly and reliably in the computing environment of the edge gateway device 11.

In embodiments, the Southbound Interface of the edge gateway device 11 interfaces to the SRP 13 and to one or more downhole sensors 14 that performs measurements that characterize the operation of the SRP 13. In embodiments, the one or more downhole sensors 14 measure real-time operational data representing pump position verses load of the SRP 13. Such downhole operational data defines an image representing a closed curve graph referred to as a “Downhole Card Image” as described herein. The Southbound Interface of the gateway device 11 also interfaces to one or more surface-located sensor(s) 15 that performs measurements that characterize the operation of the SRP 13. In embodiments, the one or more surface-located sensors 15 measure real-time operational data representing loading and displacement of the polished rod of the pump unit of the SRP 13. Such surface operational data defines an image representing a closed curve graph referred to as a “Surface Card Image” as described herein. The sensor data output by the downhole sensors 14 can be collected and/or aggregated and/or otherwise processed by the edge gateway device 11 in real-time. The sensor data output by the surface-located sensors 15 can also be collected and/or aggregated and/or otherwise processed by the edge gateway device 11 in real-time.

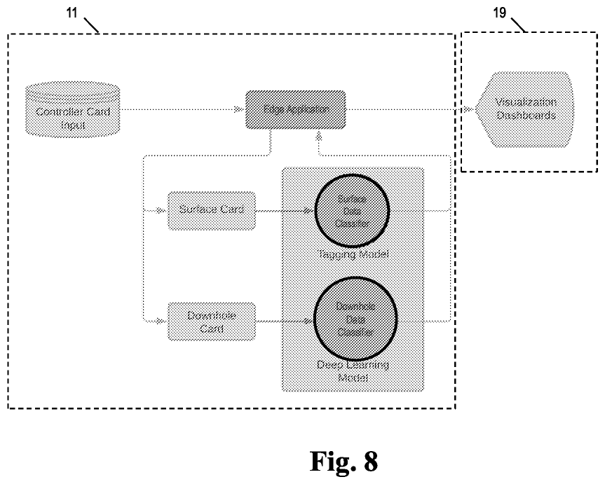

In embodiments, the edge gateway device 11 can include one or more applications that monitor operating conditions and status of the SRP 13 which is referred to as operational surveillance of the SRP. Such application(s) can be embodied by software executing in a computing environment. In this environment, such application(s) of the edge gateway device 11 process time-series data (e.g., high frequency real-time operational data) derived from the output of the downhole sensors 14 and the surface-located sensors 15 that characterizes operation of the SRP. Such applications can also embody the analysis framework of the workflow as described herein (e.g., FIG. 2) to monitor and evaluate the operating conditions or status of the SRP 13. In response to the operating conditions or status of the SRP 13 as represented by the results of the machine learning models of the workflow, the SRP 13 can possibly be controlled by commands issued from autonomous control operations performed by the edge gateway device 11 or controlled remotely by commands issued by the cloud services 19 or by another system. An example of this configuration is shown in FIG. 8 where the analysis framework of the workflow of FIG. 2 is implemented by software applications executing on the edge gateway device 11.

Furthermore, the edge gateway device 11 can communicate the result data representing the operating conditions or status of the SRP 13 to the cloud services 19. The cloud services 19 can present one or more dashboards to engineers or other users to enable such users to trigger appropriate mitigation workflows as required. The cloud services 19 can also be configured to notify one or more users of the operating conditions or status of the SRP 13. For example, the users can be notified by messaging (e.g., email messaging or in-app messaging) and/or by presentation and display of an alert or alarm or other visual or multimedia representation corresponding to operating conditions or status of the SRP 13. Such messaging can relate to repair and maintenance of the SRP 13 where appropriate. An example of this configuration is shown in FIG. 8 where the dashboard(s) provided by the cloud services 19 is labeled as “Visualization Dashboards.”

In other embodiments, the edge gateway device 11 can be configured to forward time-series data (e.g., high frequency real-time operational data) derived from the output of the downhole sensors 14 and the surface-located sensors 15 to the cloud services 19, and the cloud services 19 can be configured to process the time-series data using the analysis framework of the workflow as described herein (e.g., FIG. 2) to monitor and evaluate the operating conditions or status of the SRP 13. In response to the operating conditions or status of the SRP 13 as represented by the results of the machine learning models of the workflow, the cloud services 19 can communicate with the edge gateway device 11 to control the SRP 13 by commands issued from autonomous control operations performed by the cloud services 19 or edge gateway device 11 or controlled remotely by commands issued by the cloud services 19 or by another system. The cloud services 19 can present a dashboard to engineers or other users to enable such users to trigger appropriate mitigation workflows as required. The cloud services 19 can also be configured to notify one or more users of the operating conditions or status of the SRP 13. For example, the users can be notified by messaging (e.g., email messaging or in-app messaging) and/or by presentation and display of an alert or alarm or other visual or multimedia representation corresponding to operating conditions or status of the SRP 13. Such messaging can relate to repair and maintenance of the SRP 13 where appropriate.

The solution impact provided by an implementation of the analysis framework of the workflow as described herein (e.g., FIG. 2) deployed across one-hundred and twenty edge gateways includes the following:
Solution deployed on 120 edge gateways across two operators
Average response time of solution on edge gateway 5 seconds
Average F1-score in testing: 0.97
Reduce turnaround time for detecting & mitigating rod pump issues from 1-3 days to a few minutes

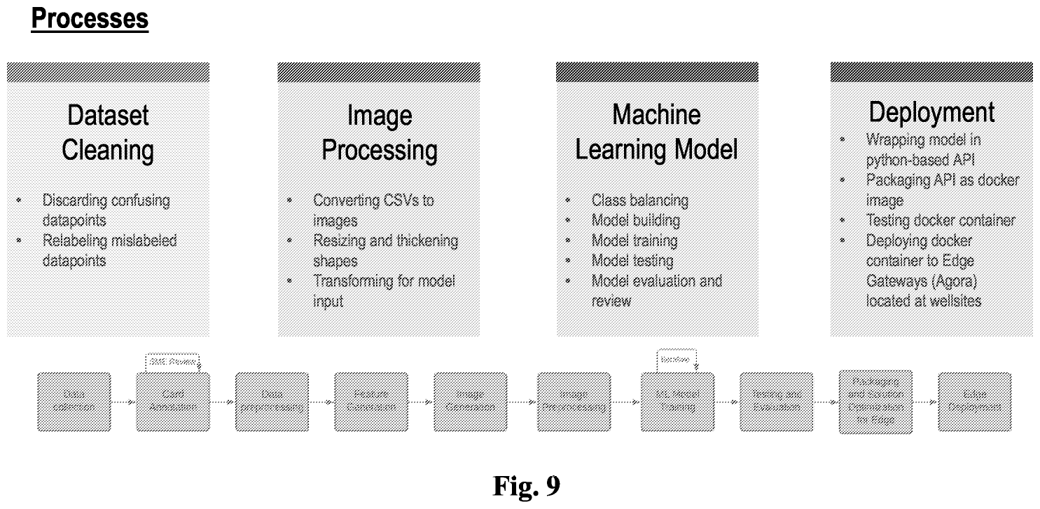

FIG. 9 shows processes that can be performed as part of the workflow.

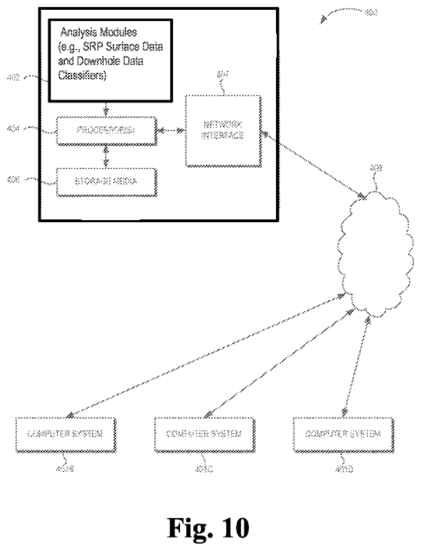

In some embodiments, the methods of the present disclosure may be executed by a computing system. FIG. 10 illustrates an example of such a computing system 400, in accordance with some embodiments. The computing system 400 may include a computer or computer system 401A, which may be an embedded computer system (e.g., edge gateway device 11 of FIG. 7) or an individual computer system or an arrangement of distributed computer systems (e.g., cloud services or cloud computing environment 19 of FIG. 7). The computer system 401A includes one or more analysis modules 402 that are configured to perform various tasks according to some embodiments, such as one or more methods or parts of the workflows as disclosed herein. To perform these various tasks, the analysis module(s) 402 executes independently, or in coordination with, one or more processors 404, which is (or are) connected to one or more storage media 406. The processor(s) 404 is (or are) also connected to a network interface 407 to allow the computer system 401A to communicate over a data network 409 with one or more additional computer systems and/or computing systems, such as 401B, 401C, and/or 401D (note that computer systems 401B, 401C and/or 401D may or may not share the same architecture as computer system 401A, and may be located in different physical locations, e.g., computer systems 401A and 401B may be located in a processing facility, while in communication with one or more computer systems such as 401C and/or 40ID that are located in one or more data centers, and/or located in varying countries on different continents).

A processor may include a microprocessor, microcontroller, processor module or subsystem, programmable integrated circuit, programmable gate array, or another control or computing device.

The storage media 406 may be implemented as one or more computer-readable or machine-readable storage media. Note that while in the example embodiment of FIG. 11 storage media 406 is depicted as within computer system 401 A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions or located at a remote site from which machine-readable instructions may be downloaded over a network for execution.

It should be appreciated that computing system 400 is only one example of a computing system, and that computing system 400 may have more or fewer components than shown, may combine additional components not depicted in the example embodiment of FIG. 11, and/or computing system 400 may have a different configuration or arrangement of the components depicted in FIG. 11. The various components shown in FIG. 11 may be implemented in hardware, software, or a combination of both hardware and software, including one or more signal processing and/or application-specific integrated circuits.

Further, the steps in the processing methods and workflows described herein may be implemented by running one or more functional modules in information processing apparatus such as general-purpose processors or application-specific chips, such as ASICs, FPGAs, PLDs, or other appropriate devices. These modules, combinations of these modules, and/or their combination with general hardware are all included within the scope of protection of the invention.

The workflow of the present disclosure can provide a number of advantages, including the following: (a) significant reduction in review time spent by engineers or other users by allowing for efficient real-time prediction of pump operation diagnosis from multiple days to a few minutes; (b) the use of advanced retrainable deep learning-based models, which can be trained on high-fidelity datasets validated by subject matter experts (SMEs) that supports online learning expansion; (c) the workflow is reliable and accurate with low response times; (d) the workflow can be packaged with lightweight versions of the original models with a smaller deployment size to optimize edge deployment; (e) the workflow can be extended to include different or additional diagnosis classes or categories of operational conditions or status of an SRP; (f) the workflow can be implemented on edge gateways (controllers) that are located at wellsites and connected to single or multiple SRPs, which may communicate directly with applications that execute on the edge gateways (controllers); (g) the workflow can potentially be deployed as a cloud-based service that interacts with internet-enabled devices; (h) the workflow can be used as a standalone decision-making tool or incorporated into a more complex workflow as a subset of the pump diagnosis infrastructure; (i) the machine learnings models of the workflow can be configured to employ an ensemble of production expertise-based domain inputs and state-of-the-art machine learning techniques; (j) the workflow can be configured to trigger an enhanced autonomous control procedure of an SRP, which can improve pump efficiency thereby increasing fluid production; (k) the workflow is platform-agnostic, i.e., it can be deployed on cloud-based services, on edge, or directly on client premises/platforms; (l) the workflow is more accurate and reliable compared to current technology as it considers both downhole and surface conditions; (m) the workflow can reduce maintenance costs of SRPs; (n) the workflow can be easily integrated into pump diagnosis solutions that may be field or client-specific in nature; and (o) the workflow can be configured to diagnose client-customized SRP operating conditions, with client-customized confidence thresholds for decision-making, and client-customized output visualization.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A method for monitoring operation of a sucker rod pump (SRP), comprising:
i) generating or collecting or obtaining surface operational data related to operation of the SRP;
ii) processing the surface operational data to generate input data for supply to a first machine learning model;
iii) generating or collecting or obtaining downhole operational data related to operation of the SRP;
iv) processing the downhole operational data to generate input data for supply to a second machine learning model; and
v) using output of at least one of the first and second machine learning models to characterize an operational condition or status of the SRP.

2. A method according to claim 1, further comprising:
communicating an alert based on the operational condition or status of v).

3. A method according to claim 1, further comprising:
planning and performing maintenance operations of the SRP based on the operational condition or status of v).

4-5. (canceled)

6. A method according to claim 1, wherein:
the input data supplied to the first machine learning model represents a histogram of oriented gradient (HOG) features derived from the surface operational data.

7. A method according to claim 1, wherein:
the first machine learning model comprises a support vector machine (SVM) classifier.

8. A method according to claim 1, wherein:
the second machine learning model is trained to predict a set of operational states or conditions of the SRP given the input data derived from the downhole operational data; and
the second machine learning model is configured to selectively predict a set of operational states or conditions of the SRP if the first machine learning model predicts that the SRP is Not Tagging.

9-10. (canceled)

11. A method according to claim 1, wherein:
the input data supplied to the second machine learning model represents an image derived from the downhole operational data.

12. A method according to claim 11, wherein:
the image is derived from data representing downhole operational characteristics of the SRP.

13. A method according to claim 1, wherein:
the second machine learning model is a convolutional neural network model.

14. A method according to claim 1, wherein:
the SRP is located at a wellsite, and some or all of the operations are performed by a software application executing on a gateway or edge controller located at or near the wellsite.

15. A method according to claim 1, wherein:
the SRP is located at a wellsite and some or all of the operations are performed by a software application executing on a remote system (such as a cloud service or cloud computing environment) that communicates with a gateway or edge controller located at or near the wellsite.

16. A system for monitoring operation of a sucker rod pump (SRP), comprising at least one processor configured to perform the operations of claim 1.

17. A system for monitoring operation of a sucker rod pump (SRP) located at a wellsite, comprising:
at least one surface sensor located at the wellsite, wherein the at least one surface sensor is configured to measure surface data related to operation of the SRP;
at least one downhole sensor located at the wellsite, wherein the at least one downhole sensor is configured to measure downhole data related to operation of the SRP; and
a gateway device located at or near the wellsite, wherein the gateway device is operably coupled to the at least one surface sensor and the at least one downhole sensor;
wherein the gateway device is configured to generate or collect or obtain surface operational data from the surface data measured by the at least one surface sensor as well as generate or collect or obtain downhole operational data from the downhole data measured by the at least one downhole sensor; and
wherein the gateway device or a remote system operably coupled to the gateway device is configured to perform operations that characterize operation of the SRP, wherein the operations involve
i) processing the surface operational data to generate input data for supply to a first machine learning model;
ii) processing the downhole operational data to generate input data for supply to a second machine learning model; and
iii) using output of at least one of the first and second machine learning models to characterize an operational condition or status of the SRP.

18. A system according to claim 17, wherein:
the first machine learning model is trained to predict whether the SRP is Tagging or Not Tagging given the input data derived from the surface operational data.

19. A system according to claim 18, wherein:
the first machine learning model is trained to predict probabilities or confidence levels for two operational states or conditions of the SRP representing whether the SRP is Tagging or Not Tagging.

20-21. (canceled)

22. A system according to claim 17, wherein:
the second machine learning model is trained to predict a set of operational states or conditions of the SRP given the input data derived from the downhole operational data.

23. A system according to claim 17, wherein:
the second machine learning model is configured to selectively predict a set of operational states or conditions of the SRP based on results of the first machine learning model.

24. A system according to claim 23, wherein:
the second machine learning model is configured to selectively predict a set of operational states or conditions of the SRP if the first machine learning model predicts that the SRP is Not Tagging.

25. A system according to claim 17, wherein:
the input data supplied to the second machine learning model represents an image derived from the downhole operational data. and
the image is derived from data representing downhole operational characteristics of the SRP.

28-29. (canceled)

30. A system according to claim 17, wherein:
the gateway device is further configured to forward both the surface operational data and the downhole operations data to the remote system, which performs the operations that characterize operation of the SRP.

31-33. (canceled)
